(19) United States
(12) Patent Application Publication
(10) Pub. No.: US 2016/0338014 A1
(43) Pub. Date: Nov. 17, 2016

(54) RESOURCE INDICATION METHOD, APPARATUS, AND SYSTEM

(71) Applicant: Huawei Technologies Co., Ltd., Shenzhen (CN)

(72) Inventors: Xingwei Zhang, Beijing (CN); Qiang Li, Doha (QA); Sha Ma, Beijing (CN)

(21) Appl. No.: 15/217,755

(22) Filed: Jul. 22, 2016

Related U.S. Application Data
(63) Continuation of application No. PCT/CN2014/071414, filed on Jan. 24, 2014.

(51) Int. Cl. H04W 72/02; H04W 4/00

(52) U.S. Cl. CPC H04W 72/02; H04W 4/005

(57) ABSTRACT

Embodiments of the present disclosure disclose a resource indication method. The method provided in the embodiments of the present disclosure is applied to a device-to-device communications system, where the D2D communications system includes at least one first node and one second node, and the method includes: receiving, by the first node, control signaling sent by the second node, where the control signaling includes an indication identifier and resource indication information corresponding to the indication identifier, and the resource indication information is used to indicate a resource used when data is transmitted; and determining, by the first node according to the indication identifier, to receive data or send data on the resource indicated by the resource indication information.

### CROSS-REFERENCE TO RELATED APPLICATIONS

This application is a continuation of International Application No. PCT/CN2014/071414, filed on Jan. 24, 2014, which is hereby incorporated by reference in its entirety.

### TECHNICAL FIELD

The present disclosure relates to the communications field, and in particular, to a resource indication method, an apparatus, and a system.

### BACKGROUND

Currently, a resource indication method is generally applied to a resource scheduling process, where the resource indication method is specifically: sending, by a base station, control signaling to a terminal, so that the terminal learns a resource location according to the control signaling. In a process of scheduling an uplink resource, the terminal sends data at the resource location, and in a process of scheduling a downlink resource, the terminal receives data at the resource location. In the process of scheduling an uplink resource, because the base station knows the resource location, only the terminal needs to be informed of the resource location.

As a service of an excessively high rate (for example, a high-definition video) emerges, load of a wireless communications network is increasingly heavy. To improve a data rate and system performance, a concept of a D2D (device to device) communications system is proposed. In the D2D communications system, one terminal may communicate with another terminal without requiring data forwarding by using a base station, where both the terminals performing communication need to learn a resource location. According to a resource indication method in the prior art, a terminal that sends data on an uplink by scheduling an uplink resource may learn a resource location used to send the data. However, a terminal that receives data on a downlink cannot learn a resource location used to receive the data. To resolve the problem, extra control signaling may be used to notify the terminal that receives the data on the downlink, of a resource location at which the data is to be received, which certainly increases overhead of the control signaling.

### SUMMARY

Embodiments of the present disclosure provide a resource indication method, an apparatus, and a system, so as to reduce overhead of control signaling.

To achieve the foregoing objective, the following technical solutions are used in the embodiments of the present disclosure.

According to a first aspect, a resource indication method is provided, and is applied to a device-to-device D2D communications system, where the D2D communications system includes at least one first node and one second node. The method includes receiving, by the first node, control signaling sent by the second node, where the control signaling includes an indication identifier and resource indication information corresponding to the indication identifier, and the resource indication information is used to indicate a resource used when data is transmitted. The method further includes determining, by the first node according to the indication identifier, to receive data or send data on the resource indicated by the resource indication information.

With reference to the first aspect, in a first possible implementation manner, the determining, by the first node according to the indication identifier, to receive data or send data on the resource indicated by the resource indication information includes determining, by the first node, whether the indication identifier is the same as an identifier of the first node, and when the indication identifier is different from the identifier of the first node, determining to receive data on the resource indicated by the resource indication information.

With reference to the first aspect, in a second possible implementation manner, the determining, by the first node according to the indication identifier, to receive data or send data on the resource indicated by the resource indication information includes determining, by the first node, whether the indication identifier is the same as an identifier of the first node, and when the indication identifier is the same as the identifier of the first node, determining to send data on the resource indicated by the resource indication information.

With reference to the first aspect and either the first possible implementation manner or the second possible implementation manner of the first aspect, in a third possible implementation manner, before the receiving, by the first node, control signaling sent by the second node, the method further includes sending, by the first node, a resource scheduling request message to the second node, where the resource scheduling request message is used to make the second node send the control signaling to the first node.

With reference to the first aspect and either the first possible implementation manner or the third possible implementation manner of the first aspect, in a fourth possible implementation manner, the control signaling further includes a cluster identifier of a cluster in which the second node is located. Additionally, the determining, by the first node according to the indication identifier, to receive data or send data on the resource indicated by the resource indication information includes determining, by the first node according to the cluster identifier and the indication identifier, to receive data or send data on the resource indicated by the resource indication information.

With reference to the first aspect and either the first possible implementation manner or the fourth possible implementation manner of the first aspect, in a fifth possible implementation manner, the indication identifier includes one of the following pieces of information: the indication identifier being a temporary identity ID of a device in the cluster, the indication identifier being a D2D ID of the device, the indication identifier being a temporary cell ID of the device, the indication identifier being an international mobile subscriber identification number IMSI of the device, the indication identifier being an international mobile equipment identity IME of the device, and the indication identifier being a subscriber identity module SIM number of the device.

With reference to the first aspect and either the first possible implementation manner or the fifth possible implementation manner of the first aspect, in a sixth possible implementation manner, the resource indication information includes information indicating a frequency domain position in which the resource is located, and/or information indicating a time domain position in which the resource is located.

With reference to the sixth possible implementation manner of the first aspect, in a seventh possible implementation manner, the information indicating the frequency domain position in which the resource is located includes: information indicating a relative frequency domain position of the resource in a resource pool; and/or the information indicating the time domain position in which the resource is located includes information indicating a relative time domain position of the resource in the resource pool, and where the resource pool is constituted of a resource that can be allocated by the second node to the first node.

With reference to the seventh possible implementation manner of the first aspect, in an eighth possible implementation manner, before the determining, by the first node according to the indication identifier, to receive data or send data on the resource indicated by the resource indication information, the method further includes receiving, by the first node, a system message sent by the second node, where the system message includes information used to indicate the resource pool, or receiving a broadcast message sent by the second node, where the broadcast message includes information used to indicate the resource pool; or receiving semi-static signaling sent by the second node, where the semi-static signaling includes information used to indicate the resource pool.

With reference to the first aspect, in a ninth possible implementation manner, the receiving, by the first node, control signaling sent by the second node includes receiving, by the first node in common search space of a physical control channel, the control signaling sent by the second node.

According to a second aspect, a resource indication method is provided, and is applied to a device-to-device D2D communications system, where the D2D communications system includes at least one first node and one second node, and the method includes determining, by the second node, control signaling, where the control signaling includes an indication identifier and resource indication information, and the resource indication information is used to indicate a resource used when data is transmitted. The method further includes sending, by the second node, the control signaling, where the control signaling is used to make a first node receiving the control signaling determine, according to the indication identifier, to receive data or send data on the resource indicated by the resource indication information.

With reference to the second aspect, in a first possible implementation manner, before the determining, by the second node, control signaling, the method further includes receiving, by the second node, a resource scheduling request message sent by a first node, where the resource scheduling request message is used to make the second node send the control signaling.

With reference to the second aspect or the first possible implementation manner of the second aspect, in a second possible implementation manner, the control signaling further includes a cluster identifier of a cluster in which the second node is located, and the cluster identifier is used to make a first node that is in the cluster corresponding to the cluster identifier and that receives the control signaling determine, according to the indication identifier, to receive data or send data on the resource indicated by the resource indication information.

With reference to the second aspect and either the first possible implementation manner or the second possible implementation manner of the second aspect, in a third possible implementation manner, the resource indication information includes: information indicating a relative frequency domain position of the resource in a resource pool, and/or information indicating a relative time domain position of the resource in the resource pool, where the resource pool is constituted of a resource that can be allocated by the second node to the at least one first node.

With reference to the third possible implementation manner of the second aspect, in a fourth possible implementation manner, the method further includes sending, by the second node, a system message to the first node receiving the control signaling, where the system message includes information used to indicate the resource pool, or sending, by the second node, a broadcast message to the first node receiving the control signaling, where the broadcast message includes information used to indicate the resource pool, or sending, by the second node, semi-static signaling to the first node receiving the control signaling, where the semi-static signaling includes information used to indicate the resource pool.

With reference to the second aspect, in a fifth possible implementation manner, the sending, by the second node, the control signaling includes sending, by the second node, the control signaling in common search space of a physical control channel.

According to a third aspect, a node is provided, and is applied to a device-to-device D2D communications system, where the D2D communications system further includes at least a second node, and the node includes a receiving unit, configured to receive control signaling sent by the second node, where the control signaling includes an indication identifier and resource indication information corresponding to the indication identifier, and the resource indication information is used to indicate a resource used when data is transmitted, and a determining unit, configured to determine, according to the indication identifier, to receive data or send data on the resource indicated by the resource indication information.

With reference to the third aspect, in a first possible implementation manner, the determining unit is specifically configured to: determine whether the indication identifier is the same as an identifier of the node; and when the indication identifier is different from the identifier of the node, determine to receive data on the resource indicated by the resource indication information.

With reference to the third aspect, in a second possible implementation manner, the determining unit is specifically configured to: determine whether the indication identifier is the same as an identifier of the node; and when the indication identifier is the same as the identifier of the node, determine to send data on the resource indicated by the resource indication information.

With reference to the third aspect and either the first possible implementation manner or the second possible implementation manner of the third aspect, in a third possible implementation manner, the node further includes a sending unit, configured to send a resource scheduling request message to the second node, where the resource scheduling request message is used to make the second node send the control signaling to the node.

With reference to the third aspect and either the first possible implementation manner or the third possible implementation manner of the third aspect, in a fourth possible implementation manner, the control signaling further includes a cluster identifier of a cluster in which the node is located, and the determining unit is specifically configured to determine, according to the cluster identifier and the indication identifier, to receive data or send data on the resource indicated by the resource indication information.

With reference to the third aspect and either the first possible implementation manner or the fourth possible implementation manner of the third aspect, in a fifth possible implementation manner, the indication identifier includes one of the following pieces of information: the indication identifier being a temporary identity ID of a device in the cluster, the indication identifier being a D2D ID of the device, the indication identifier being a temporary cell ID of the device, the indication identifier being an international mobile subscriber identification number (IMSI) of the device, the indication identifier being an international mobile equipment identity (IME) of the device, and the indication identifier being a subscriber identity module (SIM) number of the device.

With reference to the third aspect and either the first possible implementation manner or the fifth possible implementation manner of the third aspect, in a sixth possible implementation manner, the resource indication information includes: information indicating a frequency domain position in which the resource is located, and/or information indicating a time domain position in which the resource is located.

With reference to the sixth possible implementation manner of the third aspect, in a seventh possible implementation manner, the information indicating the frequency domain position in which the resource is located includes: information indicating a relative frequency domain position of the resource in a resource pool; and/or the information indicating the time domain position in which the resource is located includes: information indicating a relative time domain position of the resource in the resource pool; where the resource pool is constituted of a resource that can be allocated by the second node to the node.

With reference to the seventh possible implementation manner of the third aspect, in an eighth possible implementation manner, the receiving unit is further configured to receive a system message sent by the second node, where the system message includes information used to indicate the resource pool; or receive a broadcast message sent by the second node, where the broadcast message includes information used to indicate the resource pool; or receive semi-static signaling sent by the second node, where the semi-static signaling includes information used to indicate the resource pool.

With reference to the third aspect, in a ninth possible implementation manner, the receiving unit is specifically configured to receive, in common search space of a physical control channel, the control signaling sent by the second node.

According to a fourth aspect, a node is provided, and is applied to a device-to-device D2D communications system, where the D2D communications system further includes at least a second node, and the node includes a receiver, configured to receive control signaling sent by the second node, where the control signaling includes an indication identifier and resource indication information corresponding to the indication identifier, and the resource indication information is used to indicate a resource used when data is transmitted, and a processor, configured to determine, according to the indication identifier, to receive data or send data on the resource indicated by the resource indication information.

With reference to the fourth aspect, in a first possible implementation manner, the processor is specifically configured to determine whether the indication identifier is the same as an identifier of the node; and when the indication identifier is different from the identifier of the node, determine to receive data on the resource indicated by the resource indication information.

With reference to the fourth aspect, in a second possible implementation manner, the processor is specifically configured to determine whether the indication identifier is the same as an identifier of the node; and when the indication identifier is the same as the identifier of the node, determine to send data on the resource indicated by the resource indication information.

With reference to the fourth aspect and either the first possible implementation manner or the second possible implementation manner of the fourth aspect, in a third possible implementation manner, the node further includes a transmitter, configured to send a resource scheduling request message to the second node, where the resource scheduling request message is used to make the second node send the control signaling to the node.

With reference to the fourth aspect and either the first possible implementation manner or the third possible implementation manner of the fourth aspect, in a fourth possible implementation manner, the control signaling further includes a cluster identifier of a cluster in which the node is located, and the processor is specifically configured to determine, according to the cluster identifier and the indication identifier, to receive data or send data on the resource indicated by the resource indication information.

With reference to the fourth aspect and either the first possible implementation manner or the fourth possible implementation manner of the fourth aspect, in a fifth possible implementation manner, the indication identifier includes one of the following pieces of information the indication identifier being a temporary identity ID of a device in the cluster, the indication identifier being a D2D ID of the device, the indication identifier being a temporary cell ID of the device, the indication identifier being an international mobile subscriber identification number (IMSI) of the device, the indication identifier being an international mobile equipment identity (IME) of the device, and the indication identifier being a subscriber identity module (SIM) number of the device.

With reference to the fourth aspect and either the first possible implementation manner or the fifth possible implementation manner of the fourth aspect, in a sixth possible implementation manner, the resource indication information includes: information indicating a frequency domain position in which the resource is located, and/or information indicating a time domain position in which the resource is located.

With reference to the sixth possible implementation manner of the fourth aspect, in a seventh possible implementation manner, the information indicating the frequency domain position in which the resource is located includes: information indicating a relative frequency domain position of the resource in a resource pool; and/or the information indicating the time domain position in which the resource is located includes: information indicating a relative time domain position of the resource in the resource pool; where the resource pool is constituted of a resource that can be allocated by the second node to the node.

With reference to the seventh possible implementation manner of the fourth aspect, in an eighth possible implementation manner, the receiver is further configured to receive a system message sent by the second node, where the system message includes information used to indicate the resource pool; or receive a broadcast message sent by the second node, where the broadcast message includes information used to indicate the resource pool; or receive semi-static signaling sent by the second node, where the semi-static signaling includes information used to indicate the resource pool.

With reference to the fourth aspect, in a ninth possible implementation manner, the receiver is specifically configured to receive, in common search space of a physical control channel, the control signaling sent by the second node.

According to a fifth aspect, a node is provided, and is applied to a device-to-device D2D communications system, where the D2D communications system further includes at least one first node, and the node includes a determining unit, configured to determine control signaling, where the control signaling includes an indication identifier and resource indication information, and the resource indication information is used to indicate a resource used when data is transmitted, and a sending unit, configured to send the control signaling, where the control signaling is used to make a first node receiving the control signaling determine, according to the indication identifier, to receive data or send data on the resource indicated by the resource indication information.

With reference to the fifth aspect, in a first possible implementation manner, the node further includes a receiving unit, configured to receive a resource scheduling request message sent by a first node, where the resource scheduling request message is used to make the node send the control signaling.

With reference to the fifth aspect or the first possible implementation manner of the fifth aspect, in a second possible implementation manner, the control signaling further includes a cluster identifier of a cluster in which the node is located, and the cluster identifier is used to make a first node that is in the cluster corresponding to the cluster identifier and that receives the control signaling determine, according to an identifier of the transmit end, to receive data or send data on the resource indicated by the resource indication information.

With reference to the fifth aspect and either the first possible implementation manner or the second possible implementation manner of the fifth aspect, in a third possible implementation manner, the resource indication information includes: information indicating a relative frequency domain position of the resource in a resource pool, and/or information indicating a relative time domain position of the resource in the resource pool, where the resource pool is constituted of a resource that can be allocated by the node to the at least one first node.

With reference to the third possible implementation manner of the fifth aspect, in a fourth possible implementation manner, the sending unit is further configured to send a system message to the first node receiving the control signaling, where the system message includes information used to indicate the resource pool; or send a broadcast message to the first node receiving the control signaling, where the broadcast message includes information used to indicate the resource pool; or send semi-static signaling to the first node receiving the control signaling, where the semi-static signaling includes information used to indicate the resource pool.

With reference to the fifth aspect, in a fifth possible implementation manner, the sending unit is specifically configured to send the control signaling in common search space of a physical control channel.

According to a sixth aspect, a node is provided, and is applied to a device-to-device D2D communications system, where the D2D communications system further includes at least one first node, and the node includes a processor, configured to determine control signaling, where the control signaling includes an indication identifier and resource indication information, and the resource indication information is used to indicate a resource used when data is transmitted; and a transmitter, configured to send the control signaling, where the control signaling is used to make a first node receiving the control signaling determine, according to the indication identifier, to receive data or send data on the resource indicated by the resource indication information.

With reference to the sixth aspect, in a first possible implementation manner, the node further includes a receiver, configured to receive a resource scheduling request message sent by a first node, where the resource scheduling request message is used to make the node send the control signaling.

With reference to the sixth aspect or the first possible implementation manner of the sixth aspect, in a second possible implementation manner, the control signaling further includes a cluster identifier of a cluster in which the node is located, and the cluster identifier is used to make a first node that is in the cluster corresponding to the cluster identifier and that receives the control signaling determine, according to an identifier of the transmit end, to receive data or send data on the resource indicated by the resource indication information.

With reference to the sixth aspect and either the first possible implementation manner or the second possible implementation manner of the sixth aspect, in a third possible implementation manner, the resource indication information includes: information indicating a relative frequency domain position of the resource in a resource pool, and/or information indicating a relative time domain position of the resource in the resource pool, where the resource pool is constituted of a resource that can be allocated by the node to the at least one first node.

With reference to the third possible implementation manner of the sixth aspect, in a fourth possible implementation manner, the transmitter is further configured to send a system message to the first node receiving the control signaling, where the system message includes information used to indicate the resource pool; or send a broadcast message to the first node receiving the control signaling, where the broadcast message includes information used to indicate the resource pool; or send semi-static signaling to the first node receiving the control signaling, where the semi-static signaling includes information used to indicate the resource pool.

With reference to the sixth aspect, in a fifth possible implementation manner, the transmitter is specifically configured to send the control signaling in common search space of a physical control channel.

According to a seventh aspect, a device-to-device D2D communications system is provided, including: at least one first node, and/or one second node, where the first node is any one of the nodes provided in the foregoing third and fourth aspects, and the second node is any one of the nodes provided in the foregoing fifth and sixth aspects.

According to the resource indication method, the apparatus, and the system provided in the embodiments of the present disclosure, a first node receives control signaling including an indication identifier and resource indication information, and determines, according to the indication identifier, to receive data or send data on a resource indicated by the resource indication information. When there are multiple first nodes that receive the control signaling, all the multiple first nodes can determine, by using the control signaling, to receive data or send data on the resource indicated by the resource indication information. Compared with the prior art in which extra control signaling is used to enable a receive end to learn a resource location, the solutions can reduce overhead of the control signaling.

### BRIEF DESCRIPTION OF THE DRAWINGS

To describe the technical solutions in the embodiments of the present disclosure more clearly, the following briefly introduces the accompanying drawings required for describing the embodiments or the prior art. Apparently, the accompanying drawings in the following description show merely some embodiments of the present disclosure, and persons of ordinary skill in the art may still derive other drawings from these accompanying drawings without creative efforts.

FIG. 1 is a schematic flowchart of a resource indication method according to Embodiment 1 of the present disclosure;

FIG. 2 is a schematic flowchart of a resource indication method according to Embodiment 2 of the present disclosure;

FIG. 3 is a schematic flowchart of a resource indication method according to Embodiment 1′ of the present disclosure;

FIG. 3a is a schematic diagram of an application scenario according to Embodiment 1′ of the present disclosure;

FIG. 4 is a schematic flowchart of a resource indication method according to Embodiment 2′ of the present disclosure;

FIG. 4a is a schematic diagram of an application scenario according to Embodiment 2′ of the present disclosure;

FIG. 5 is a schematic diagram of a structure of a node according to Embodiment 3 of the present disclosure;

FIG. 6 is a schematic diagram of a structure of another node according to Embodiment 3 of the present disclosure;

FIG. 7 is a schematic diagram of a structure of a node according to Embodiment 4 of the present disclosure;

FIG. 8 is a schematic diagram of a structure of a node according to Embodiment 5 of the present disclosure;

FIG. 9 is a schematic diagram of a structure of another node according to Embodiment 5 of the present disclosure; and

FIG. 10 is a schematic diagram of a structure of a node according to Embodiment 6 of the present disclosure.

### DETAILED DESCRIPTION OF ILLUSTRATIVE EMBODIMENTS

The following clearly describes the technical solutions in the embodiments of the present disclosure with reference to the accompanying drawings in the embodiments of the present disclosure. Apparently, the described embodiments are merely some but not all of the embodiments of the present disclosure. All other embodiments obtained by persons of ordinary skill in the art based on the embodiments of the present disclosure without creative efforts shall fall within the protection scope of the present disclosure.

A D2D communications system is constituted of multiple nodes, where a set constituted of the multiple nodes is a cluster, and a node included in the cluster may be referred to as a cluster member. One or more nodes in the cluster may be used as a cluster head, and are used to provide a function similar to that of a base station, for example, allocating, to the cluster member, a resource used to send data, and providing time synchronization required for data transmission. It should be noted that although one cluster may include multiple cluster heads, in general, only one cluster head may be used to allocate a resource to the cluster member. A “cluster head” mentioned below refers to a cluster head used to allocate a resource to a cluster member.

In a scenario in which there is network coverage, the nodes in the D2D communications system generally include a base station and a terminal; in the scenario, the base station is generally used as a cluster head, and certainly, the terminal may also be used as the cluster head. In a scenario in which there is no network coverage, the nodes in the D2D communications system may include only terminals. The terminals in the D2D communications system are generally multiple terminals in a same area or multiple terminals of a same service type. It should be noted that in the scenario in which there is network coverage, the nodes in the D2D communications system may also include only terminals.

In addition, the term “and/or” in the specification describes only an association relationship for describing associated objects and represents that three relationships may exist. For example, A and/or B may represent the following three cases: Only A exists, both A and B exist, and only B exists. In addition, the character “/” in the specification generally indicates an “or” relationship between the associated objects.

### Embodiment 1

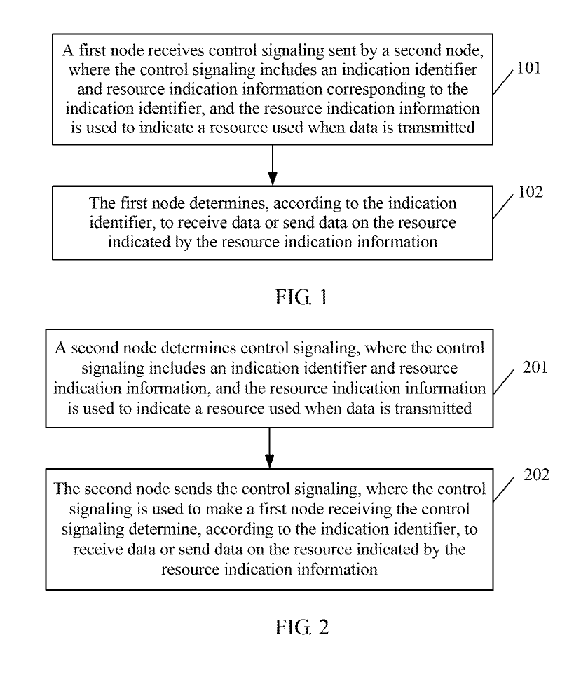

In this embodiment, a resource indication method provided in this embodiment of the present disclosure is described in terms of a node receiving control signaling (that is, a “first node”), where the method is applied to a device-to-device D2D communications system, and the D2D communications system includes at least one first node and one second node. As shown in FIG. 1, the method includes:

101. The first node receives control signaling sent by the second node, where the control signaling includes an indication identifier and resource indication information corresponding to the indication identifier, and the resource indication information is used to indicate a resource used when data is transmitted.

The “first node” may be any node in the D2D communications system. Specifically, in a scenario in which there is network coverage, the “first node” may be a base station or a terminal; in a scenario in which there is no network coverage, the “first node” is a terminal. The resource indicated by the resource indication information may be specifically a time-frequency resource, and a resource location of the time-frequency resource.

The “second node” may be a cluster head of a cluster in which the “first node” in step 101 is located. Specifically, in the scenario in which there is network coverage, the “second node” may be a base station, and certainly, may also be a terminal; in the scenario in which there is no network coverage, the “second node” is a terminal.

The first node and the second node may be in a same cluster. When the second node is a cluster head, the second node directly sends the control signaling to the first node. When the second node is not a cluster head, the second node may forward the control signaling sent by the cluster head.

The “indication identifier” included in the “control signaling” is used to make the first node receiving the control signaling determine that the first node should receive data or send data on the resource indicated by the resource indication information. Specifically, the “indication identifier” may be an identifier of a first node, or may be an identifier of the second node.

Optionally, the indication identifier may include but is not limited to one of the following several pieces of information: the indication identifier being a temporary ID (identity) of a device in the cluster, the indication identifier being a D2D ID of the device, the indication identifier being a temporary cell ID of the device, the indication identifier being an IMSI (international mobile subscriber identification number) of the device, the indication identifier being an IME (international mobile equipment identity) of the device, and the indication identifier being a SIM (subscriber identity module) number of the device. It should be noted that in addition to the several pieces of information listed above, in specific implementation, the indication identifier may also be another symbol or user-defined identifier used to identify a node in the prior art.

The “resource indication information” is used to indicate the resource used when data is transmitted. Optionally, the resource indication information includes: information indicating a frequency domain position in which the resource is located, and/or information indicating a time domain position in which the resource is located. The resource indication information may specifically include: information indicating a relative frequency domain position of the resource in a resource pool, and/or information of a relative time domain position. The resource pool is constituted of a resource that can be allocated by the second node to the first node. The resource indication information may further specifically include: information indicating an absolute frequency domain position of the resource, and/or information of an absolute time domain position. For example, the resource pool may be system bandwidth of the entire D2D communications system. When the second node is the cluster head, the second node can allocate, to the first node, a resource that is from the resource pool and ensures that the first node initiates a communications service. When the second node is not the cluster head, the second node may forward a resource that is allocated by the cluster head and that is to be used by the first node to initiate the communications service.

The “resource indication information” may be specifically used to indicate a location of a resource that is allocated by the second node to the first node, where the resource allocated by the second node to the first node refers to a resource scheduled by the second node in the resource pool. An implementation method in which the second node obtains the resource pool is not limited in this embodiment of the present disclosure. For example, the resource pool may be allocated by the base station, or may be obtained by the second node by means of contention. In addition, an implementation manner in which the second node uses which resource as the resource allocated to the first node is not limited in this embodiment of the present disclosure.

Optionally, a step in which the “first node” obtains the “resource pool” may be executed before or after step 101. In addition, a method in which the “first node” in step 101 obtains the “resource pool” includes but is not limited to the following three manners:

(i) The first node receives a system message sent by the second node, where the system message includes information used to indicate the resource pool. The system message is used to notify some specific parameters in the system and is shared by all nodes in the system, and the system message is periodically sent.

(ii) The first node receives a broadcast message sent by the second node, where the broadcast message includes information used to indicate the resource pool. That the first node receives the broadcast message sent by the second node specifically includes: receiving, in a physical broadcast channel, the broadcast message sent by the second node, where the broadcast message includes the information used to indicate the resource pool.

(iii) The first node receives semi-static signaling sent by the second node, where the semi-static signaling includes information used to indicate the resource pool. The semi-static signaling may be: RRC (Radio Resource Control) signaling, a MAC CE (MAC control element), or the like.

That “the first node receives control signaling sent by the second node” may be: the first node receives the control signaling sent by the second node in a broadcast/multicast/unicast manner. There may be one or more first nodes that receive same control signaling sent by the second node. When there is only one first node that receives the same control signaling, the second node sends the control signaling in the unicast manner; when there are at least two first nodes that receive the same control signaling, the second node sends the control signaling in the broadcast/multicast manner. Further, in the latter case, when the first nodes that receive the same control signaling are first nodes within a range, the second node sends the control signaling in the broadcast manner; when the first nodes that receive the same control signaling are first nodes with a same characteristic (for example, belonging to a same cluster) within a range, the second node sends the control signaling in the multicast manner.

Optionally, step 101 may include: receiving, by the first node, in common search space of a physical control channel, the control signaling sent by the second node.

102. The first node determines, according to the indication identifier, to receive data or send data on the resource indicated by the resource indication information.

In an embodiment of the present disclosure, step 102 may include: determining whether the indication identifier is the same as an identifier of the first node; and when the indication identifier is different from the identifier of the first node, determining to receive data on the resource indicated by the resource indication information.

In another embodiment of the present disclosure, step 102 may include: determining whether the indication identifier is the same as an identifier of the first node; and when the indication identifier is the same as the identifier of the first node, determining to send data on the resource indicated by the resource indication information.

Optionally, the control signaling may further include a cluster identifier of a cluster in which the second node is located; in this case, step 102 may include: determining, by the first node according to the cluster identifier and the indication identifier, to receive data or send data on the resource indicated by the resource indication information. It should be noted that a cluster member stores a cluster identifier of a cluster in which the cluster member is located, and specifically, when joining a cluster, a node may store a cluster identifier of the cluster.

Exemplarily, step 102 may be specifically: when a cluster identifier in the control signaling is the same as a cluster identifier of the cluster in which the first node is located, determining, by the first node according to the indication identifier, to receive data or send data on the resource indicated by the resource indication information. It should be noted that when the cluster identifier in the control signaling is different from the cluster identifier of the cluster in which the first node is located, the first node cannot obtain the control signaling by parsing, and therefore the first node cannot obtain a resource allocated by the second node. This optional manner may prevent a first node that does not belong to a cluster corresponding to the cluster identifier in the control signaling from acquiring the resource allocated by the second node, thereby improving security assurance.

In an embodiment of the present disclosure, before step 101, the method may further include: sending, by the first node, a resource scheduling request message to the second node, where the resource scheduling request message is used to make the second node send the control signaling.

Exemplarily, when any cluster member except a cluster head in a cluster has a requirement for data sending, the cluster member sends a resource scheduling request message to the second node (when it is assumed that the second node is the cluster head). The resource scheduling request message may include an indication identifier, where the indication identifier is an identifier of the cluster member, so that the second node determines control signaling according to the indication identifier.

In addition, the second node may also obtain the indication identifier in the following manner: the second node may pre-allocate, to each first node, a resource block used to send a resource scheduling request message, and store a correspondence between each first node and the resource block that is allocated to the first node and that is used to send a resource scheduling request message. In this way, when one of the first nodes sends a resource scheduling request message by using the resource block that is allocated to the first node and that is used to send the resource scheduling request message, the second node may acquire an identifier of the first node according to the correspondence between the first node and the resource block that is used to send the resource scheduling request message, and use the identifier as the indication identifier.

According to the resource indication method provided in this embodiment of the present disclosure, a first node receives control signaling including an indication identifier and resource indication information, and determines, according to the indication identifier, to receive data or send data on a resource indicated by the resource indication information. When there are multiple first nodes that receive the control signaling, all the multiple first nodes can determine, by using the control signaling, to receive data or send data on the resource indicated by the resource indication information, which implements resource scheduling of a cluster member in a same cluster using only one piece of control. Compared with the prior art in which extra control signaling is used to enable different first nodes to learn a resource location, the solution can reduce overhead of the control signaling.

### Embodiment 2

In this embodiment, a resource indication method provided in this embodiment of the present disclosure is described in terms of a node sending control signaling (that is, a “second node”), where the method is applied to a device-to-device D2D communications system, and the D2D communications system includes at least one first node and one second node. As shown in FIG. 2, the method includes:

201. The second node determines control signaling, where the control signaling includes an indication identifier and resource indication information, and the resource indication information is used to indicate a resource used when data is transmitted.

Optionally, the “indication identifier” may include but is not limited to one of the following several pieces of information: the indication identifier being a temporary ID of a device in a cluster, the indication identifier being a D2D ID of the device, the indication identifier being a temporary cell ID of the device, the indication identifier being an IMSI of the device, the indication identifier being an IME of the device, and the indication identifier being a SIM number of the device. In addition, the indication identifier may also be another symbol or user-defined identifier used to identify a node in the prior art.

The “resource indication information” is used to indicate the resource used when data is transmitted. Optionally, the resource indication information includes: information indicating a frequency domain position in which the resource is located, and/or information indicating a time domain position in which the resource is located. The resource indication information may specifically include: information indicating a relative frequency domain position of the resource in a resource pool, and/or information of a relative time domain position. The resource pool is constituted of a resource that can be allocated by the second node to the first node. The resource indication information may further specifically include: information indicating an absolute frequency domain position of the resource, and/or information of an absolute time domain position.

The “resource indication information” may be specifically used to indicate a location of a resource that is allocated by the second node to the first node, where the resource allocated by the second node to the first node refers to a resource scheduled by the second node in the resource pool. An implementation method in which the second node obtains the resource pool is not limited in this embodiment of the present disclosure. For example, the resource pool may be allocated by the base station, or may be obtained by the second node by means of contention. In addition, an implementation manner in which the second node uses which resource as a resource allocated by the first node is not limited in this embodiment of the present disclosure.

Optionally, a method in which a “first node receiving the control signaling” obtains the “resource pool” includes but is not limited to the following three manners: (i) sending a system message to the first node receiving the control signaling, where the system message includes information used to indicate the resource pool; (iii) sending a broadcast message to the first node receiving the control signaling, where the broadcast message includes information used to indicate the resource pool; or sending semi-static signaling to the first node receiving the control signaling, where the semi-static signaling includes information used to indicate the resource pool. A step in which the first node obtains the “resource pool” may be executed before or after step 201.

202. The second node sends the control signaling, where the control signaling is used to make a first node receiving the control signaling determine, according to the indication identifier, to receive data or send data on the resource indicated by the resource indication information.

Optionally, step 202 may include: sending, by the second node, the control signaling in common search space of a physical control channel.

In an embodiment of the present disclosure, before step 201, the method may further include: receiving, by the second node, a resource scheduling request message sent by a first node, where the resource scheduling request message is used to make the second node send the control signaling.

Exemplarily, the resource scheduling request message may include an indication identifier, and in this case, the indication identifier is an identifier of the first node, so that the second node determines control signaling according to the indication identifier. In addition, the second node may also obtain the indication identifier in the following manner: the second node may pre-allocate, to each first node, a resource block used to send a resource scheduling request message, and store a correspondence between each first node and the resource block that is allocated to the first node and that is used to send a resource scheduling request message. In this way, when one of the first nodes sends a resource scheduling request message by using the resource block that is allocated to the first node and that is used to send the resource scheduling request message, the second node may acquire an identifier of the first node according to the correspondence between the first node and the resource block that is used to send the resource scheduling request message, and use the identifier as the indication identifier.

Optionally, the control signaling further includes a cluster identifier of a cluster in which the second node is located, and the cluster identifier is used to make a first node that is in the cluster corresponding to the cluster identifier and that receives the control signaling determine, according to the indication identifier, to receive data or send data on the resource indicated by the resource indication information.

It should be noted that for both a related explanation and example in this embodiment of the present disclosure, reference may be made to Embodiment 1 and the following specific embodiments.

According to the resource indication method provided in this embodiment of the present disclosure, a second node determines and sends control signaling including an indication identifier and resource indication information, so that a first node receiving the control signaling determines, according to the indication identifier, to receive data or send data on a resource indicated by the resource indication information. When there are multiple first nodes that receive the control signaling, all the multiple first nodes can determine, by using the control signaling, to receive data or send data on the resource indicated by the resource indication information. Compared with the prior art in which extra control signaling is used to enable a receive end to learn a resource location, the solution can reduce overhead of the control signaling.

The following exemplarily illustrates, by using several specific embodiments, the methods provided in the foregoing Embodiment 1 and Embodiment 2. When the following specific embodiments are applied to a scenario in which there is network coverage, the embodiments are described by using an example in which nodes in a D2D communications system generally include a base station and a terminal. In addition, for related explanations and examples in the following specific embodiments, reference may be made to related parts in the foregoing Embodiment 1 and Embodiment 2.

### Embodiment 1′

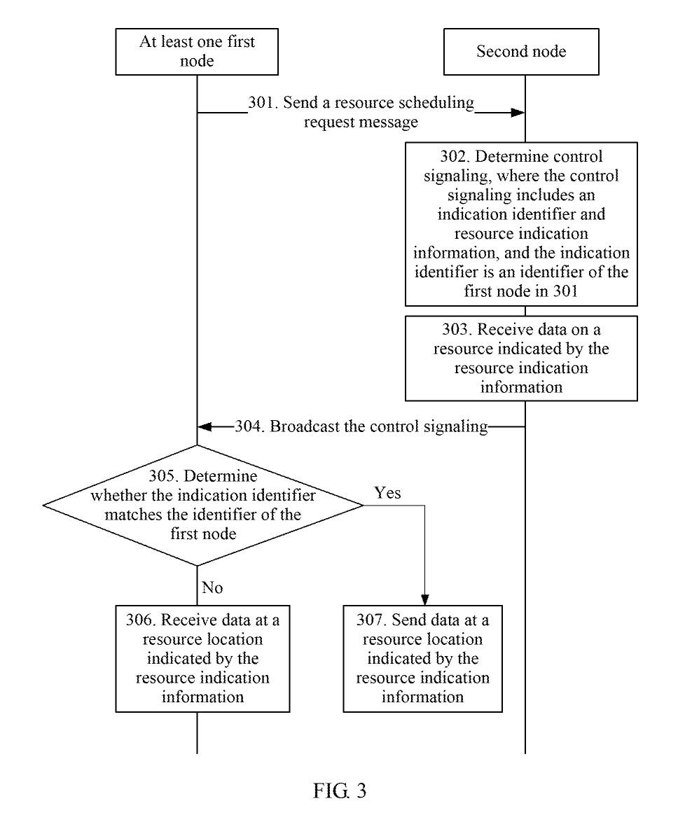

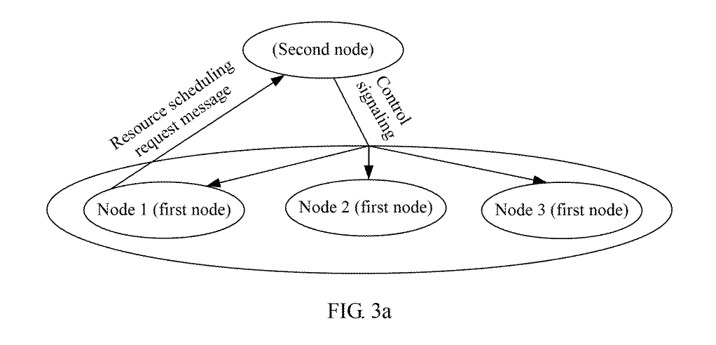

In this embodiment, an “indication identifier” is an identifier of a first node. As shown in FIG. 3, a resource indication method provided in this embodiment includes:

301. The first node sends a resource scheduling request message to a second node, where the resource scheduling request message includes the identifier of the first node.

302. The second node determines control signaling, where the control signaling includes an indication identifier and resource indication information, the indication identifier is the identifier of the first node in step 301, and resource scheduling indication information is used to indicate a resource used when data is transmitted.

Optionally, the resource indication information specifically includes the following three cases:

(1) The resource indication information is information indicating a frequency domain position in which the resource is located. Specifically, a location of the frequency domain in which the resource is located is indicated in RB (resource block) or RBG (resource block group) units from a frequency domain perspective, where an indication type may be: a bitmap of an RB/RBG or three resource indication types (Type 0/1/2) defined in an existing LTE (Long Term Evolution) system.

It should be noted that in this case, a first node receiving the control signaling may receive data or send data in a specific preset subframe from a time domain perspective. For example, the first node receives the control signaling in the Nth subframe, and may receive data or send data in the (N+k)th subframe, where a value of k is not limited in this embodiment of the present disclosure. Optionally, for FDD (frequency division duplex), k=4; for TDD (time division duplex), k=4, 5, 6, or 7.

(2) The resource indication information is information indicating a time domain position in which the resource is located. Specifically, a location of the time domain position in which the resource is located is indicated in subframe units from a time domain perspective, where the location of the time domain in which the resource is located may be indicated by using a bitmap method. For example, the location of the time domain in which the resource is located may be indicated by using a map of 10 bits “1000011001”, where the map indicates that the location of the time domain in which the resource is located is a subframe numbered #0, #5, #6, or #9.

It should be noted that in this case, the first node receiving the control signaling may receive data or send data in a specific preset RB or RBG or in full bandwidth.

(3) The resource indication information is information indicating a frequency domain position in which the resource is located and information indicating a time domain position in which the resource is located. Specifically, a location of the frequency domain in which the resource is located is indicated in RB or RBG units from a frequency domain perspective, where an indication type may be: a bitmap of the RB/RBG or three resource indication types (Type 0/1/2) defined in an existing LTE system. A location of the time domain in which the resource is located is indicated in subframe units from a time domain perspective, where a bitmap of a subframe may be indicated, or a period is indicated. The location of the time domain in which the resource is located is indicated by using a period T. If a first node receives control signaling in the Nth subframe, the first node may receive data or send data in the (N+kT)th subframe, where k=1, 2, 3, . . . .

303. The second node receives data on the resource indicated by the resource indication information.

304. The second node broadcasts the control signaling.

305. A first node receiving the control signaling determines whether the indication identifier is the same as an identifier of the first node.

If the indication identifier is different from the identifier of the first node, step 306 is executed; if the indication identifier is the same as the identifier of the first node, step 307 is executed.

306. Receive data at a resource location indicated by the resource indication information.

307. Send data at a resource location indicated by the resource indication information.

Exemplarily, it is assumed that a D2D communications system includes three first nodes and one second node, where the three first nodes are respectively: a node 1, a node 2, and a node 3, and the “first node” in step 301 is the node 1. FIG. 3a is a schematic diagram of information exchange in the scenario in which this embodiment is applied.

According to the resource indication method provided in this embodiment of the present disclosure, a second node determines and sends control signaling including an indication identifier and resource indication information, so that a first node receiving the control signaling determines, according to the indication identifier, to receive data or send data on a resource indicated by the resource indication information. When there are multiple first nodes that receive the control signaling, all the multiple first nodes can determine, by using the control signaling, to receive data or send data on the resource indicated by the resource indication information. Compared with the prior art in which extra control signaling is used to enable a receive end to learn a resource location, the solution can reduce overhead of the control signaling.

### Embodiment 2′

In this embodiment, an indication identifier is an identifier of a “second node”. As shown in FIG. 3, a resource indication method provided in this embodiment includes:

401. The second node determines control signaling, where the control signaling includes an indication identifier and resource indication information, the indication identifier is the identifier of the second node, and resource scheduling indication information is used to indicate a resource used when data is transmitted.

Exemplarily, for a specific representation manner and application of the resource indication information, reference may be made to step 302 in the foregoing Embodiment 1′, and details are not described herein again.

402. The second node sends data on the resource indicated by the resource indication information.

Optionally, step 402 may be executed in any step after step 401.

403. The second node broadcasts the control signaling.

404. A first node receiving the control signaling determines whether the indication identifier is the same as an identifier of the first node.

If the indication identifier is different from the identifier of the first node, step 405 is executed; if the indication identifier is the same as the identifier of the first node, step 406 is executed.

It should be noted that in a scenario of this embodiment, because the indication identifier is the identifier of the second node, and the second node and the first node are different nodes, a determining result in step 404 is generally that the indication identifier is different from the identifier of the first node.

405. Receive data at a resource location indicated by the resource indication information.

406. Send data at a resource location indicated by the resource indication information.

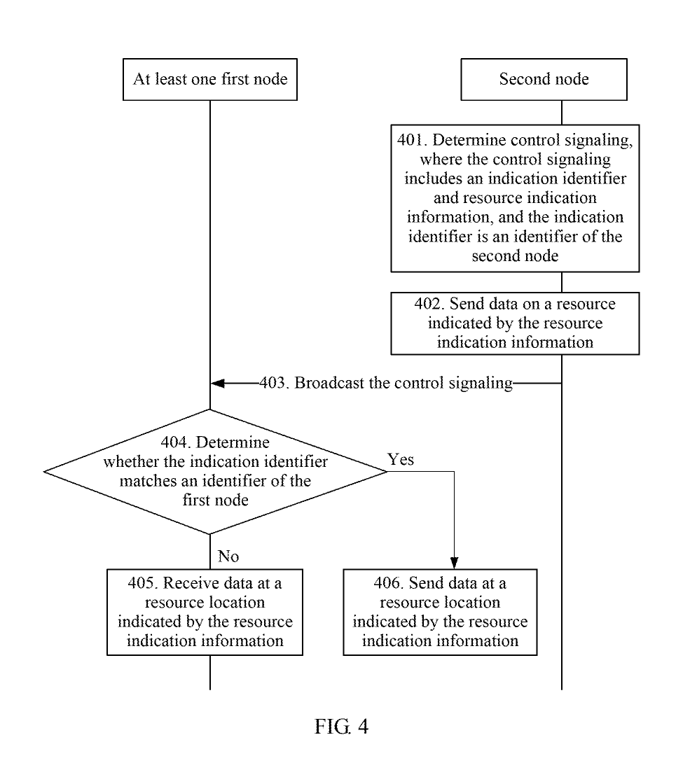

Exemplarily, it is assumed that a D2D communications system includes three first nodes and one second node, where the three first nodes are respectively: a node 1, a node 2, and a node 3, and the “first node” in step 404 is the node 1. FIG. 4a is a schematic diagram of information exchange in the scenario in which this embodiment is applied.

According to the resource indication method provided in this embodiment of the present disclosure, a second node determines and sends control signaling including an indication identifier and resource indication information, so that a first node receiving the control signaling determines, according to the indication identifier, to receive data or send data on a resource indicated by the resource indication information. When there are multiple first nodes that receive the control signaling, all the multiple first nodes can determine, by using the control signaling, to receive data or send data on the resource indicated by the resource indication information. Compared with the prior art in which extra control signaling is used to enable a receive end to learn a resource location, the solution can reduce overhead of the control signaling.

### Embodiment 3

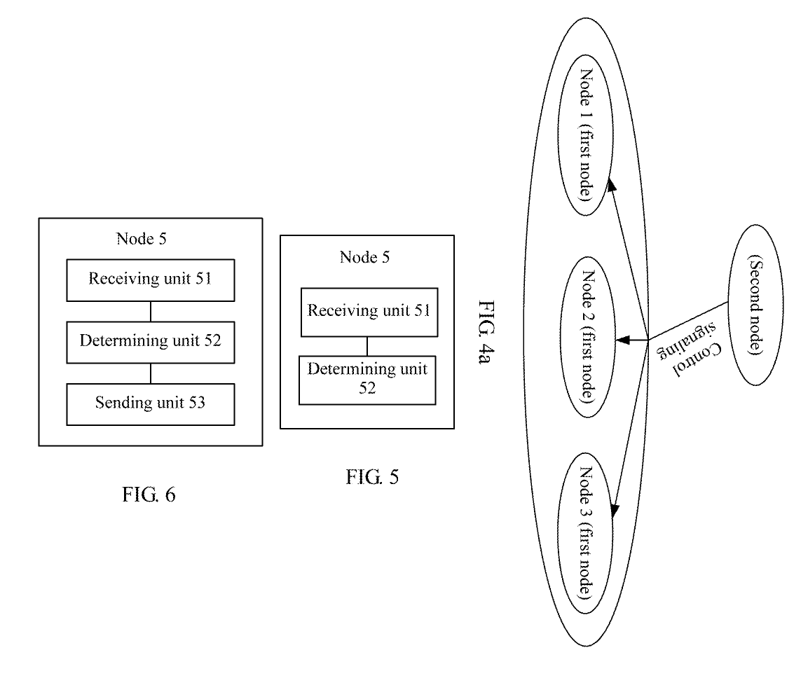

As shown in FIG. 5, a node 5 is provided in this embodiment of the present disclosure, and is applied to a device-to-device D2D communications system, where the D2D communications system further includes at least a second node. The node is used to execute the resource indication method shown in FIG. 1. The node 5 includes a receiving unit 51, configured to receive control signaling sent by the second node, where the control signaling includes an indication identifier and resource indication information corresponding to the indication identifier, and the resource indication information is used to indicate a resource used when data is transmitted, and a determining unit 52, configured to determine, according to the indication identifier, to receive data or send data on the resource indicated by the resource indication information.

Optionally, the determining unit 52 is specifically configured to: determine whether the indication identifier is the same as an identifier of the node 5; and when the indication identifier is different from the identifier of the node 5, determine to receive data on the resource indicated by the resource indication information.

Optionally, the determining unit 52 is specifically configured to: determine whether the indication identifier is the same as an identifier of the node 5; and when the indication identifier is the same as the identifier of the node 5, determine to send data on the resource indicated by the resource indication information.

Optionally, as shown in FIG. 6, the node 5 further includes a sending unit 53, configured to send a resource scheduling request message to the second node, where the resource scheduling request message is used to make the second node send the control signaling to the node 5.

Optionally, the control signaling further includes a cluster identifier of a cluster in which the node 5 is located; and the determining unit 52 is specifically configured to determine, according to the cluster identifier and the indication identifier, to receive data or send data on the resource indicated by the resource indication information.

Optionally, the indication identifier includes one of the following pieces of information: the indication identifier being a temporary identity ID of a device in the cluster, the indication identifier being a D2D ID of the device, the indication identifier being a temporary cell ID of the device, the indication identifier being an international mobile subscriber identification number IMSI of the device, the indication identifier being an international mobile equipment identity IME of the device, and the indication identifier being a subscriber identity module SIM number of the device.

Optionally, the resource indication information includes: information indicating a frequency domain position in which the resource is located, and/or information indicating a time domain position in which the resource is located.

Optionally, the information indicating the frequency domain position in which the resource is located includes: information indicating a relative frequency domain position of the resource in a resource pool; and/or the information indicating the time domain position in which the resource is located includes: information indicating a relative time domain position of the resource in the resource pool; where the resource pool is constituted of a resource that can be allocated by the second node to the node 5.

Optionally, the receiving unit 51 is further configured to receive a system message sent by the second node, where the system message includes information used to indicate the resource pool; or receive a broadcast message sent by the second node, where the broadcast message includes information used to indicate the resource pool; or receive semi-static signaling sent by the second node, where the semi-static signaling includes information used to indicate the resource pool.

Optionally, the receiving unit 51 is specifically configured to receive, in common search space of a physical control channel, the control signaling sent by the second node.

Exemplarily, the node 5 in this embodiment may be the “first node” described in the foregoing embodiment. In a scenario in which there is network coverage, the node 5 may be a base station or a terminal; in a scenario in which there is no network coverage, the node 5 may be a terminal. In addition, an “indication message” may be an identifier of the node 5, or may be an identifier of the second node.

According to the node provided in this embodiment of the present disclosure, control signaling including an indication identifier and resource indication information is received, and it is determined, according to the indication identifier, to receive data or send data on a resource indicated by the resource indication information. When there are multiple nodes that receive the control signaling, all the multiple nodes can determine, by using the control signaling, to receive data or send data on the resource indicated by the resource indication information. Compared with the prior art in which extra control signaling is used to enable a receive end to learn a resource location, the solution can reduce overhead of the control signaling.

### Embodiment 4

In hardware implementation, the sending unit in Embodiment 3 may be a transmitter, the receiving unit may be a receiver, and the transmitter and the receiver may be integrated to form a transceiver.

The determining unit may be built in or independent of a processor of user equipment UE in a hardware form, or may be stored in a memory of the node 5 in a software form, so that the processor invokes and executes an operation corresponding to each of the foregoing modules. The processor may be a central processing unit (CPU), a microprocessor, a single-chip microcomputer, or the like.

As shown in FIG. 7, a node 5 is provided in this embodiment of the present disclosure, and is applied to a device-to-device D2D communications system, where the D2D communications system further includes at least a second node. The node is used to execute the resource indication method shown in FIG. 1. The node 5 includes: a memory 71, a receiver 72, a processor 73, and a bus system 74.

The memory 71, the receiver 72, and the processor 73 are coupled together by using the bus system 74, where the bus system 74 may further include a power bus, a control bus, a status signal bus, and the like, in addition to a data bus. However, for clarity of description, various buses are marked as the bus system 74 in the figure.

The memory 71 is configured to store a set of code.

The code stored in the memory 71 is used to control the receiver 72 to receive control signaling sent by the second node, where the control signaling includes an indication identifier and resource indication information corresponding to the indication identifier, and the resource indication information is used to indicate a resource used when data is transmitted.

The code stored in the memory 71 is further used to control the processor 73 to determine, according to the indication identifier, to receive data or send data on the resource indicated by the resource indication information.

Optionally, the processor 73 is specifically configured to: determine whether the indication identifier is the same as an identifier of the node 5; and when the indication identifier is different from the identifier of the node 5, determine to receive data on the resource indicated by the resource indication information.

Optionally, the processor 73 is specifically configured to: determine whether the indication identifier is the same as an identifier of the node 5; and when the indication identifier is the same as the identifier of the node 5, determine to send data on the resource indicated by the resource indication information.

Optionally, the node 5 further includes a transmitter 75, configured to send a resource scheduling request message to the second node, where the resource scheduling request message is used to make the second node send the control signaling to the node 5.

Optionally, the control signaling further includes a cluster identifier of a cluster in which the node 5 is located; and the processor 73 is specifically configured to determine, according to the cluster identifier and the indication identifier, to receive data or send data on the resource indicated by the resource indication information.

Optionally, the indication identifier includes one of the following pieces of information: the indication identifier being a temporary identity ID of a device in the cluster, the indication identifier being a D2D ID of the device, the indication identifier being a temporary cell ID of the device, the indication identifier being an international mobile subscriber identification number (IMSI) of the device, the indication identifier being an international mobile equipment identity (IME) of the device, and the indication identifier being a subscriber identity module (SIM) number of the device.

Optionally, the resource indication information includes: information indicating a frequency domain position in which the resource is located, and/or information indicating a time domain position in which the resource is located.

Optionally, the information indicating the frequency domain location in which the resource is located includes: information indicating a relative frequency domain position of the resource in a resource pool; and/or the information indicating the time domain position in which the resource is located includes: information indicating a relative time domain position of the resource in the resource pool; where the resource pool is constituted of a resource that can be allocated by the second node to the node 5.

Optionally, the receiver 72 is further configured to: receive a system message sent by the second node, where the system message includes information used to indicate the resource pool; or receive a broadcast message sent by the second node, where the broadcast message includes information used to indicate the resource pool; or receive semi-static signaling sent by the second node, where the semi-static signaling includes information used to indicate the resource pool.

Optionally, the receiver 72 is specifically configured to receive, in common search space of a physical control channel, the control signaling sent by the second node.

Exemplarily, the node 5 in this embodiment may be the “first node” described in the foregoing embodiment. In a scenario in which there is network coverage, the node 5 may be a base station or a terminal; in a scenario in which there is no network coverage, the node 5 may be a terminal. In addition, an “indication message” may be an identifier of a node 5, or may be an identifier of the second node.

According to the node provided in this embodiment of the present disclosure, control signaling including an indication identifier and resource indication information is received, and it is determined, according to the indication identifier, to receive data or send data on a resource indicated by the resource indication information. When there are multiple nodes that receive the control signaling, all the multiple nodes can determine, by using the control signaling, to receive data or send data on the resource indicated by the resource indication information. Compared with the prior art in which extra control signaling is used to enable a receive end to learn a resource location, the solution can reduce overhead of the control signaling.

### Embodiment 5

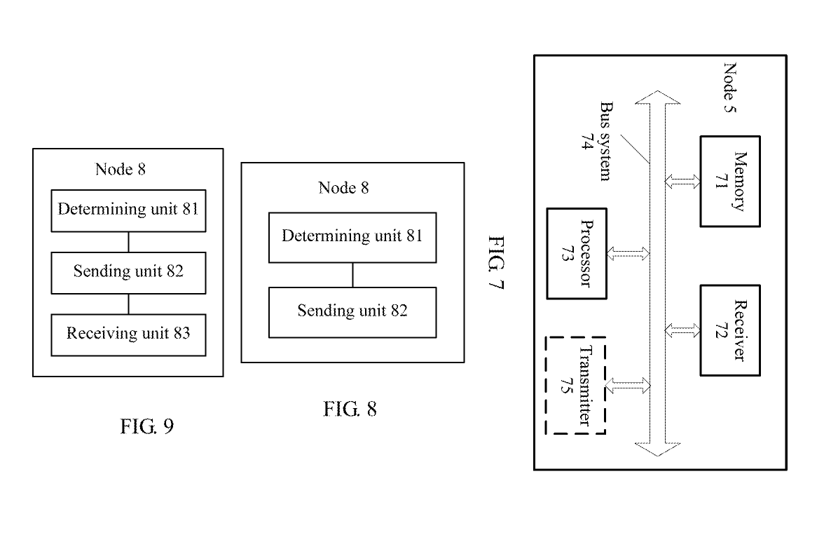

As shown in FIG. 8, a node 8 is provided in this embodiment of the present disclosure, and is applied to a device-to-device D2D communications system, where the D2D communications system further includes at least one first node. The node 8 is used to execute the resource indication method shown in FIG. 2. The node 8 includes a determining unit 81, configured to determine control signaling, where the control signaling includes an indication identifier and resource indication information, and the resource indication information is used to indicate a resource used when data is transmitted; and a sending unit 82, configured to send the control signaling, where the control signaling is used to make a first node receiving the control signaling determine, according to the indication identifier, to receive data or send data on the resource indicated by the resource indication information.

Optionally, as shown in FIG. 9, the node 8 further includes a receiving unit 83, configured to receive a resource scheduling request message sent by a first node, where the resource scheduling request message is used to make the node 8 send the control signaling.

Optionally, the control signaling further includes a cluster identifier of a cluster in which the node 8 is located, and the cluster identifier is used to make a first node that is in the cluster corresponding to the cluster identifier and that receives the control signaling determine, according to an identifier of the transmit end, to receive data or send data on the resource indicated by the resource indication information.

Optionally, the resource indication information includes: information indicating a relative frequency domain position of the resource in a resource pool, and/or information indicating a relative time domain location of the resource in the resource pool, where the resource pool is constituted of a resource that can be allocated by the node 8 to the at least one first node.

Optionally, the sending unit 82 is further configured to: send a system message to the first node receiving the control signaling, where the system message includes information used to indicate the resource pool; or send a broadcast message to the first node receiving the control signaling, where the broadcast message includes information used to indicate the resource pool; or send semi-static signaling to the first node receiving the control signaling, where the semi-static signaling includes information used to indicate the resource pool.

Optionally, the sending unit 82 is specifically configured to send the control signaling in common search space of a physical control channel.

Exemplarily, the node 8 in this embodiment may be the “second node” described in the foregoing embodiment. In addition, an “indication message” may be an identifier of a first node, or may be an identifier of the node 8.

According to the node provided in this embodiment of the present disclosure, control signaling including an indication identifier and resource indication information is determined and sent, so that a first node receiving the control signaling determines, according to the indication identifier, to receive data or send data on a resource indicated by the resource indication information. When there are multiple first nodes that receive the control signaling, all the multiple first nodes can determine, by using the control signaling, to receive data or send data on the resource indicated by the resource indication information. Compared with the prior art in which extra control signaling is used to enable a receive end to learn a resource location, the solution can reduce overhead of the control signaling.

### Embodiment 6

In hardware implementation, the sending unit in Embodiment 5 may be a transmitter, the receiving unit may be a receiver, and the transmitter and the receiver may be integrated to form a transceiver.

The determining unit may be built in or independent of a processor of user equipment UE in a hardware form, or may be stored in a memory of the node 8 in a software form, so that the processor invokes and executes an operation corresponding to each of the foregoing modules. The processor may be a central processing unit (CPU), a microprocessor, a single-chip microcomputer, or the like.

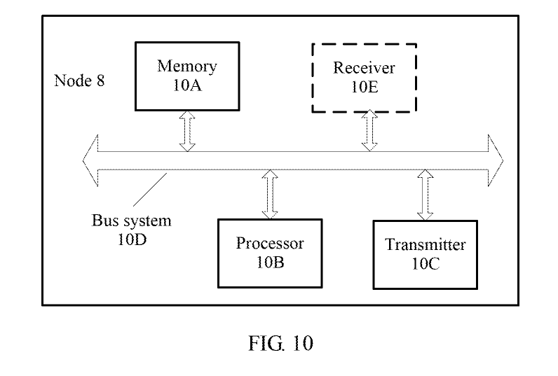

As shown in FIG. 10, a node 8 is provided in this embodiment of the present disclosure, and is applied to a device-to-device D2D communications system, where the D2D communications system further includes at least one first node. The node 8 is used to execute the resource indication method shown in FIG. 2. The node 8 includes: a memory 10A, a processor 10B, a transmitter 10C, and a bus system 10D.

The memory 10A, the processor 10B, and the transmitter 10C are coupled together by using the bus system 10D, where the bus system 10D may further include a power bus, a control bus, a status signal bus, and the like, in addition to a data bus. However, for clarity of description, various buses are marked as the bus system 10D in the figure.

The memory 10A is configured to store a set of code.

The code stored in the memory 10A is used to control the processor 10B to determine control signaling, where the control signaling includes an indication identifier and resource indication information, and the resource indication information is used to indicate a resource used when data is transmitted.

The code stored in the memory 10A is further used to control the transmitter 10C to send the control signaling, where the control signaling is used to make a first node receiving the control signaling determine, according to the indication identifier, to receive data or send data on the resource indicated by the resource indication information.

Optionally, the node 8 further includes a receiver 10E, configured to receive a resource scheduling request message sent by a first node, where the resource scheduling request message is used to make the node 8 send the control signaling.

Optionally, the control signaling further includes a cluster identifier of a cluster in which the node 8 is located, and the cluster identifier is used to make a first node that is in the cluster corresponding to the cluster identifier and that receives the control signaling determine, according to an identifier of the transmit end, to receive data or send data on the resource indicated by the resource indication information.

Optionally, the resource indication information includes: information indicating a relative frequency domain location of the resource in a resource pool, and/or information indicating a relative time domain location of the resource in the resource pool, where the resource pool is constituted of a resource that can be allocated by the node 8 to the at least one first node.

Optionally, the transmitter 10C is further configured to: send a system message to the first node receiving the control signaling, where the system message includes information used to indicate the resource pool; or send a broadcast message to the first node receiving the control signaling, where the broadcast message includes information used to indicate the resource pool; or send semi-static signaling to the first node receiving the control signaling, where the semi-static signaling includes information used to indicate the resource pool.

Optionally, the transmitter 10C is specifically configured to send the control signaling in common search space of a physical control channel.

Exemplarily, the node 8 in this embodiment may be the “second node” described in the foregoing embodiment. In addition, an “indication message” may be an identifier of a first node, or may be an identifier of the node 8.

According to the node provided in this embodiment of the present disclosure, control signaling including an indication identifier and resource indication information is determined and sent, so that a first node receiving the control signaling determines, according to the indication identifier, to receive data or send data on a resource indicated by the resource indication information. When there are multiple first nodes that receive the control signaling, all the multiple first nodes can determine, by using the control signaling, to receive data or send data on the resource indicated by the resource indication information. Compared with the prior art in which extra control signaling is used to enable a receive end to learn a resource location, the solution can reduce overhead of the control signaling.

### Embodiment 7

This embodiment of the present disclosure further provides a device-to-device D2D communications system, including at least one first node and one second node.

The second node is any one of the nodes 8 provided in the foregoing Embodiment 5 and Embodiment 6, and is configured to determine and send control signaling, where the control signaling includes an indication identifier and resource indication information, the resource indication information is used to indicate a resource used when data is transmitted, and the control signaling is used to make a first node receiving the control signaling determine, according to the indication identifier, to receive data or send data on the resource indicated by the resource indication information.

The first node is any one of the nodes 5 provided in the foregoing Embodiment 3 and Embodiment 4, and is configured to: receive control signaling sent by the second node, where the control signaling includes an indication identifier and resource indication information corresponding to the indication identifier, and the resource indication information is used to indicate a resource used when data is transmitted; and determine, according to the indication identifier, to receive data or send data on the resource indicated by the resource indication information.

The D2D communications system provided in this embodiment of the present disclosure includes at least one first node and one second node. The first node receives control signaling including an indication identifier and resource indication information, and determines, according to the indication identifier, to receive data or send data on a resource indicated by the resource indication information. When there are multiple first nodes that receive the control signaling, all the multiple first nodes can determine, by using the control signaling, to receive data or send data on the resource indicated by the resource indication information. Compared with the prior art in which extra control signaling is used to enable a receive end to learn a resource location, the solution can reduce overhead of the control signaling.

It may be clearly understood by persons skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of hardware in addition to a software functional unit.

When the foregoing integrated unit is implemented in a form of a software functional unit, the integrated unit may be stored in a computer-readable storage medium. The software functional unit is stored in a storage medium and includes several instructions for instructing a computer device (which may be a personal computer, a server, or a network device) to perform some of the steps of the methods described in the embodiments of the present disclosure. The foregoing storage medium includes: any medium that can store program code, such as a USB flash drive, a removable hard disk, a read-only memory (ROM for short), a random access memory (RAM for short), a magnetic disk, or an optical disc.

Finally, it should be noted that the foregoing embodiments are merely intended for describing the technical solutions of the present disclosure but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present disclosure.

What is claimed is:

1. A resource indication method, comprising:
receiving, by a first node of a device-to-device (D2D) communications system having at least one first node and one second node, control signaling sent by the second node, wherein the control signaling comprises an indication identifier and resource indication information corresponding to the indication identifier, and the resource indication information is used to indicate a resource used when data is transmitted; and
determining, by the first node according to the indication identifier, to receive data or send data on the resource indicated by the resource indication information.

2. The resource indication method according to claim 1, wherein the determining to receive data or send data on the resource indicated by the resource indication information comprises:
determining, by the first node, whether the indication identifier is the same as an identifier of the first node; and
determining, in response to the indication identifier being different from the identifier of the first node, to receive data on the resource indicated by the resource indication information.

3. The resource indication method according to claim 1, wherein the determining to receive data or send data on the resource indicated by the resource indication information comprises:
determining, by the first node, whether the indication identifier is the same as an identifier of the first node; and
determining, in response to the indication identifier being the same as the identifier of the first node, to send data on the resource indicated by the resource indication information.

4. The resource indication method according to claim 1, wherein the control signaling further comprises a cluster identifier of a cluster in which the second node is located; and
wherein the determining to receive data or send data on the resource indicated by the resource indication information comprises:
determining, by the first node according to the cluster identifier and the indication identifier, to receive data or send data on the resource indicated by the resource indication information.

5. The resource indication method according to claim 1, wherein the indication identifier comprises one of the indication identifier being a temporary identity ID of a device in the cluster, the indication identifier being a D2D ID of the device, the indication identifier being a temporary cell identifier (ID) of the device, the indication identifier being an international mobile subscriber identification number (IMSI) of the device, the indication identifier being an international mobile equipment identity (IME) of the device, and the indication identifier being a subscriber identity module (SIM) number of the device.

6. The resource indication method according to claim 1, wherein the resource indication information comprises at least one of information indicating a frequency domain position in which the resource is located or information indicating a time domain position in which the resource is located.

7. The resource indication method according to claim 6, wherein at least one of the information indicating the frequency domain position in which the resource is located comprises information indicating a relative frequency domain position of the resource in a resource pool, or the information indicating the time domain position in which the resource is located comprises information indicating a relative time domain position of the resource in the resource pool; and
wherein the resource pool is constituted of a resource that can be allocated by the second node to the first node.

8. The resource indication method according to claim 7, wherein the method further comprises performing, before the determining to receive data or send data on the resource indicated by the resource indication information, at least one of:
receiving, by the first node, a system message sent by the second node, wherein the system message comprises information used to indicate the resource pool;
receiving a broadcast message sent by the second node, wherein the broadcast message comprises information used to indicate the resource pool; and
receiving semi-static signaling sent by the second node, wherein the semi-static signaling comprises information used to indicate the resource pool.

9. A node, applied to a device-to-device (D2D) communications system, wherein the D2D communications system further comprises at least a second node, and the node comprises:
a receiver, configured to receive control signaling sent by the second node, wherein the control signaling comprises an indication identifier and resource indication information corresponding to the indication identifier, and the resource indication information is used to indicate a resource used when data is transmitted; and
a processor; and
a non-transitory computer-readable storage medium storing a program to be executed by the processor, the program including instructions for:
determine, according to the indication identifier, to receive data or send data on the resource indicated by the resource indication information.

10. The node according to claim 9, wherein program further includes instructions to:
determine whether the indication identifier is the same as an identifier of the node; and
determine, in response to the indication identifier being different from the identifier of the node, to receive data on the resource indicated by the resource indication information.

11. The node according to claim 9, wherein program further includes instructions to:
determine whether the indication identifier is the same as an identifier of the node; and
determine, in response to the indication identifier being the same as the identifier of the node, to send data on the resource indicated by the resource indication information.

12. The node according to claim 9, wherein the indication identifier comprises one of the indication identifier being a temporary identity ID of a device in the cluster, the indication identifier being a D2D identifier (ID) of the device, the indication identifier being a temporary cell ID of the device, the indication identifier being an international mobile subscriber identification number (IMSI) of the device, the indication identifier being an international mobile equipment identity (IME) of the device, and the indication identifier being a subscriber identity module SIM number of the device.

13. The node according to claim 9, wherein the resource indication information comprises at least one of information indicating a frequency domain position in which the resource is located, or information indicating a time domain position in which the resource is located.

14. The node according to claim 13, wherein at least one of the information indicating the frequency domain position in which the resource is located comprises information indicating a relative frequency domain position of the resource in a resource pool, or the information indicating the time domain position in which the resource is located comprises: information indicating a relative time domain position of the resource in the resource pool; and
wherein the resource pool is constituted of a resource that can be allocated by the second node to the node.

15. The node according to claim 14, wherein the receiver is further configured to:
receive at least one of a system message sent by the second node, wherein the system message comprises information used to indicate the resource pool, a broadcast message sent by the second node, wherein the broadcast message comprises information used to indicate the resource pool, semi-static signaling sent by the second node, wherein the semi-static signaling comprises information used to indicate the resource pool.

16. A node of a device-to-device (D2D) communications system, the node comprising:
a processor; and
a non-transitory computer-readable storage medium storing a program to be executed by the processor, the program including instructions to:
determine control signaling, wherein the control signaling comprises an indication identifier and resource indication information, and the resource indication information is used to indicate a resource used when data is transmitted; and
a transmitter, configured to send the control signaling, wherein the control signaling is used to make a first node receiving the control signaling determine, according to the indication identifier, to receive data or send data on the resource indicated by the resource indication information, wherein the D2D communications system comprises at least one first node.

17. The node according to claim 16, wherein the node further comprises:
a receiver, configured to receive a resource scheduling request message sent by the first node, wherein the resource scheduling request message is used to make the node send the control signaling.

18. The node according to claim 16, wherein the control signaling further comprises a cluster identifier of a cluster in which the node is located, and wherein the cluster identifier is used to make a first node that is in the cluster corresponding to the cluster identifier and that receives the control signaling determine, according to an identifier of a transmit end, to receive data or send data on the resource indicated by the resource indication information.

19. The node according to claim 16, wherein the resource indication information comprises at least one of information indicating a relative frequency domain position of the resource in a resource pool or information indicating a relative time domain position of the resource in the resource pool; and
wherein the resource pool is constituted of a resource that can be allocated by the node to the at least one first node.

20. The node according to claim 19, wherein the transmitter is further configured to perform at least one of:
send a system message to the first node receiving the control signaling, wherein the system message comprises information used to indicate the resource pool;
send a broadcast message to the first node receiving the control signaling, wherein the broadcast message comprises information used to indicate the resource pool; and
send semi-static signaling to the first node receiving the control signaling, wherein the semi-static signaling comprises information used to indicate the resource pool.
